(19) United States
(12) Patent Application Publication
(10) Pub. No.: US 2026/0140466 A1
(43) Pub. Date: May 21, 2026

(54) IMAGE FORMING APPARATUS

(71) Applicant: CANON KABUSHIKI KAISHA, Tokyo (JP)

(72) Inventors: SHIGERU HIRANO, Tokyo (JP); KOICHI KAKUBARI, Chiba (JP); SHIGERU TANAKA, Tokyo (JP); HIROTO ITO, Chiba (JP); MADOKA WATANABE, Chiba (JP)

(21) Appl. No.: 19/385,538

(22) Filed: Nov. 11, 2025

(30) Foreign Application Priority Data
Nov. 18, 2024 (JP) 2024-200635

(51) Int. Cl. G03G 15/20; G03G 15/00; G03G 15/01; G03G 15/08

(52) U.S. Cl. CPC G03G 15/2025; G03G 15/0105; G03G 15/0189; G03G 15/0865; G03G 15/2064; G03G 15/50; G03G 2215/2038

(57) ABSTRACT

An image forming apparatus includes a photosensitive member on which an electrostatic latent image is formed, a development unit that develops the electrostatic latent image into a toner image with toner, a transfer unit that transfers the toner image onto a recording material, a fixing unit that includes a first rotating member and a second rotating member that form a fixing nip portion in which the toner image is fixed to the recording material by applying heat and pressure, a cleaning unit that includes a web for removing toner and a winding unit that winds the web, and cleans a surface of the first rotating member, a driving unit that drives the winding unit, a storage unit that stores information related to melting characteristics of toner contained in a toner bottle, and a control unit that controls the driving unit based on the information.

### BACKGROUND

### Field of the Technology

The present disclosure relates to image forming apparatuses, such as a printer, a copying machine, a facsimile, and a multi-function peripheral, which use an electrophotographic technique.

### Description of the Related Art

An image forming apparatus includes a fixing device for fixing a toner image formed on a recording material by applying heat and pressure to the recording material. The fixing device includes a fixing roller and a pressure roller for holding and conveying the recording material while applying heat and pressure to the recording material. Moreover, an image forming apparatus which includes a cleaning unit for mainly removing toner adhered to a fixing roller including a built-in heat source has been conventionally proposed.

In an apparatus described in Japanese Patent Laid-Open No. 2004-212409, a cleaning unit includes a cleaning roller for cleaning the surface of a fixing roller and a cleaning web for removing the toner transferred to the cleaning roller from the fixing roller. The portion of the cleaning web (hereinafter, simply referred to as “web”) already used for removing toner from the cleaning roller is not used again for toner removal. Therefore, in the cleaning unit, the web is wound up while being used to clean the cleaning roller, so that an unused portion of the web can be used for removing toner from the cleaning roller. The web that has been completely used is removed and replaced with a new web.

In recent year, image forming apparatuses have been increasingly designed to save energy by reducing the power consumption of a fixing device, which accounts for a large portion of the overall power consumption, and by shortening the warm-up time of the fixing device. In order to reduce the power consumption of the fixing device, it is necessary to lower the target temperature of the fixing device. The target temperature of the fixing device for acquiring an appropriate image varies depending on the melting characteristics of toner when the toner is subjected to heat and pressure treatment. Therefore, Japanese Patent Laid-Open No. 2020-194024 proposes a technique for correcting the target temperature of the fixing device based on information representing the thermal characteristics of the toner, such as a melting point.

### SUMMARY

According to an aspect of the present disclosure, an image forming apparatus includes a photosensitive member on which an electrostatic latent image is formed, a development unit configured to develop the electrostatic latent image formed on the photosensitive member into a toner image with toner, a transfer unit configured to transfer the toner image on the photosensitive member onto a recording material, a fixing unit including a first rotating member and a second rotating member that is in contact with the first rotating member to form a fixing nip portion in which the toner image is fixed to the recording material by applying heat and pressure while holding and conveying the recording material, a cleaning unit including a web for removing toner and a winding unit configured to wind the web, and configured to clean the first rotating member by removing toner adhering to a surface of the first rotating member, a driving unit configured to drive the winding unit, a storage unit configured to store information related to melting characteristics of toner contained in a toner bottle, and a control unit configured to control the driving unit based on the information stored in the storage unit.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating a configuration of an image forming apparatus according to an embodiment.

FIG. 2 is a schematic diagram illustrating configurations of a fixing device and a cleaning unit.

FIG. 3 is a schematic diagram illustrating a contact-separation mechanism of a cleaning web and a cleaning roller.

FIG. 4 is a control block diagram illustrating a control unit of the image forming apparatus.

FIG. 5 is a graph illustrating a relationship between a fixing temperature and an amount of hot offset toner for each of recording materials having different basis weights.

FIG. 6 is a flowchart illustrating processing from receipt of an execution instruction of an image forming job to the end of the image forming job.

FIG. 7 is a flowchart illustrating consumption amount update processing.

FIG. 8 is a flowchart illustrating correction amount update processing.

FIG. 9 is a graph illustrating the transition of a web conveyance amount according to the number of times of replenishment.

FIG. 10 is a graph illustrating the transition of a web conveyance amount caused by replacement of a toner bottle.

FIG. 11A is a graph illustrating the transition of a web conveyance amount for each color according to the number of times of replenishment in a color mode, and FIG. 11B is a graph illustrating a common setting value for all colors in the color mode.

### DESCRIPTION OF THE EMBODIMENTS

### <Image Forming Apparatus>

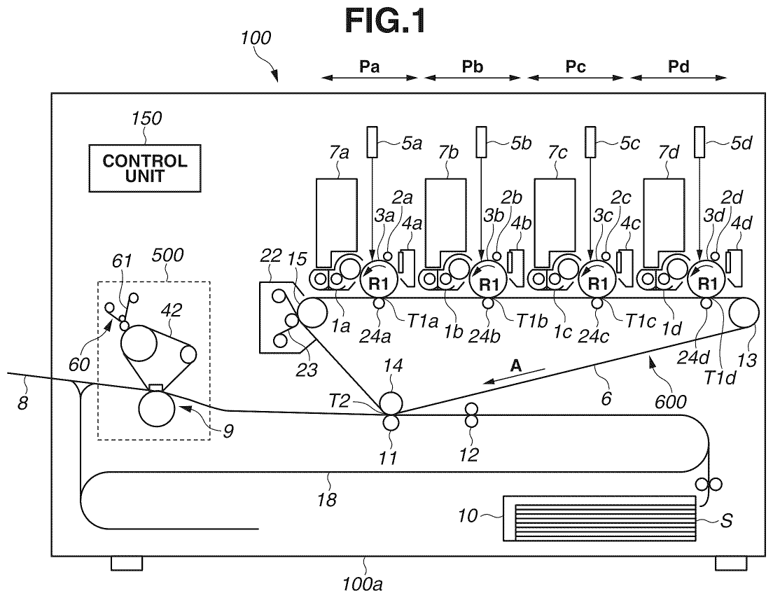

An embodiment is described with reference to drawings. First, a configuration of an image forming apparatus according to the present embodiment is described with reference to FIG. 1. An image forming apparatus 100 is an electrophotographic full-color printer including four image forming units Pa, Pb, Pc, and Pd for four colors: yellow, magenta, cyan, and black. In the present embodiment, the image forming units Pa, Pb, Pc, and Pd are tandem-type image forming units arranged along the rotation direction (direction of arrow A in FIG. 1) of an intermediate transfer belt 6 described below.

The image forming apparatus 100 forms a toner image on a recording material S according to image data (image signal) read by a document reading apparatus (not illustrated) connected to an apparatus main body 100a or image data (image signal) received from a host apparatus (not illustrated), such as a personal computer, communicably connected to the apparatus main body 100a. The image forming apparatus 100 according to the present embodiment can selectively execute a monochrome mode and a color mode. In the monochrome mode, the image forming apparatus 100 forms a black toner image using only the image forming unit Pd for a black color. In the color mode, the image forming apparatus 100 forms a full-color toner image using the image forming units Pa to Pd for respective colors.

As illustrated in FIG. 1, the image forming apparatus 100 includes the apparatus main body 100a. The image forming units Pa, Pb, Pc, and Pd corresponding to the respective colors, i.e., yellow (Y), magenta (M), cyan (C), and black (K) are arranged on the apparatus main body 100a. Although the image forming units Pa to Pd are different in the color of toner used, the structures of the image forming units Pa to Pd are substantially the same as each other. Therefore, in the following description, unless otherwise specified, a case of the monochrome mode using only the image forming unit Pd for a black color will be described as an example.

The image forming unit Pd includes a photosensitive drum 3d, a charging device 2d, a laser scanner 5d, a development device 1d, and a drum cleaner 4d, which are sequentially arranged along the rotation direction of the photosensitive drum 3d. In the image forming unit Pd, the photosensitive drum 3d serving as a photosensitive member is charged in advance by the charging device 2d, and then, an electrostatic latent image is formed on the photosensitive drum 3d by the laser scanner 5d. Although not illustrated in FIG. 1, the laser scanner 5d includes elements such as a light source apparatus for emitting laser light, a polygon mirror, a reflection mirror, and an fθ lens. Laser light emitted from the light source apparatus is scanned by the rotating polygon mirror, and the scanned light flux is deflected by the reflection mirror and collected onto the surface of the photosensitive drum 3d by the fθ lens, so that an electrostatic latent image according to an image signal is formed on the photosensitive drum 3d.

The development device 1d serving as a development unit develops the electrostatic latent image formed on the photosensitive drum 3d into a toner image. The development device 1d develops the electrostatic latent image formed on the photosensitive drum 3d by using a developer containing toner and visualizes the electrostatic latent image as a toner image. In the present embodiment, the photosensitive drum 3d and the development device 1d are detachably provided on the apparatus main body 100a. A new (unused) development device 1d is preloaded with a developer containing an initial amount of toner. The toner contains colored resin particles, which include a binder resin (also referred to as “binder”), coloring agent, and other additives as necessary, and colored particles, to which an external additive such as colloidal silica fine powder is externally added. The toner further contains wax in order to improve the releasability from the fixing device 9 and the fixability of the toner to the recording material S when the toner image is fixed to the recording material S. Example of the wax include polyolefin wax, long-chain hydrocarbon wax, dialkyl ketone wax, ester wax, and amide wax. The melting point of the wax ranges from 40° C. to 160° C. In a case where the melting point falls within the above range, the heat resistance of the toner can be ensured, and an image can be formed without causing image defects such as cold offset even if the image is fixed at low temperature. In addition, the content of the wax in the toner is desirably from 3% by mass to 30% by mass.

As a replenishment container for containing replenishment toner (second toner), a toner bottle 7d is detachably provided on the development device 1d. The toner (first toner) contained in the development device 1d is consumed each time an electrostatic latent image formed on the photosensitive drum 3d (photosensitive member) is developed into a toner image. Therefore, each time the amount of toner consumed reaches a predetermined amount (or each time the cumulative number of recording materials S on which images are formed reaches a predetermined number), the replenishment toner contained in the toner bottle 7d is supplied to the development device 1d.

The toner image formed on the photosensitive drum 3d is primarily transferred onto an intermediate transfer belt 6 by a primary transfer roller 24d. In other words, while the toner image formed on the photosensitive drum 3d is passing through a primary transfer nip portion Tld between the photosensitive drum 3d and the intermediate transfer belt 6, the toner image is primarily transferred to the intermediate transfer belt 6 by an electric field generated by applying a primary transfer voltage to the primary transfer roller 24d and by the pressure applied to the primary transfer nip portion Tld. Transfer residual toner remaining on the photosensitive drum 3d after the primary transfer is removed by a drum cleaner 4d.

The recording materials S are fed from a sheet feeding cassette 10, and conveyed to a registration roller pair 12 one by one. The registration roller pair 12 receives and temporarily stops the recording material S to correct a skew of the recording material S. Then, the registration roller pair 12 transfers the recording material S to a secondary transfer nip portion T2 formed between the intermediate transfer belt 6 and a secondary transfer roller 11 in synchronization with the timing at which the toner image transferred to the intermediate transfer belt 6 reaches the secondary transfer nip portion T2. The intermediate transfer belt 6 is rotated by tension rollers 13, 14, and 15 in the direction of arrow A at the same circumferential speed as the circumferential speed of the photosensitive drums 3a to 3d.

The toner image transferred to the intermediate transfer belt 6 is secondarily transferred onto the recording material S at the secondary transfer nip portion T2 by the secondary transfer roller 11. The secondary transfer roller 11 is borne in parallel with the intermediate transfer belt 6 and supported in a state of being in contact with the lower face portion of the intermediate transfer belt 6 so as to sandwich the intermediate transfer belt 6 between the secondary transfer roller 11 and the tension roller 14. A secondary transfer voltage is applied to the secondary transfer roller 11 from a bias power supply (not illustrated). The recording material S fed from the sheet feeding cassette 10 through the registration roller pair 12 is conveyed to the secondary transfer nip portion T2 at a predetermined timing, and a secondary transfer voltage is simultaneously applied to the secondary transfer roller 11 from the bias power supply, so that the toner image primarily transferred onto the intermediate transfer belt 6 is secondarily transferred onto the recording material S. In this way, the toner image is secondarily transferred onto the recording material S from the intermediate transfer belt 6. The transfer residual toner and other foreign objects remaining on the intermediate transfer belt 6 are wiped off by rubbing an unwoven fabric 23 of the belt cleaner 22 against the surface of the intermediate transfer belt 6. The above-described primary transfer rollers 24a to 24d, the intermediate transfer belt 6, the tension rollers 13, 14, and 15, and the secondary transfer roller 11 constitute a transfer unit 600 for transferring the toner image onto the recording material S from the photosensitive drums 3a to 3d via the intermediate transfer belt 6.

After the toner image is transferred onto the recording material S at the secondary transfer nip portion T2, the recording material S is conveyed to the fixing device 9. The fixing device 9 applies heat and pressure to the recording material S, so that the toner image formed on the recording material S is fixed to the recording material S. The recording material S having passed through the fixing device 9 is discharged to a discharge tray 8. In a case where images are formed on both sides of the recording material S, the front and back sides of the recording material S are reversed via a two-side conveyance unit 18 after a toner image is transferred and fixed to the first side (front side) of the recording material S, and a toner image is transferred and fixed to the second side (back side) of the recording material S. Thereafter, the recording material S is discharged to the discharge tray 8.

A front door 500, which can be opened and closed, is provided in the apparatus main body 100a. The user can access the fixing device 9 and the cleaning unit 60, which will be described below, arranged inside the apparatus main body 100a from outside the apparatus main body 100a by opening the front door 500. In the present embodiment, in a state where the front door 500 is opened, the user can perform maintenance work on the fixing device 9 and the cleaning unit 60, and can also perform replacement work of the web 61 provided in the cleaning unit 60 for cleaning the surface of the fixing belt 42, from the outside of the apparatus main body 100a.

### <Fixing Device>

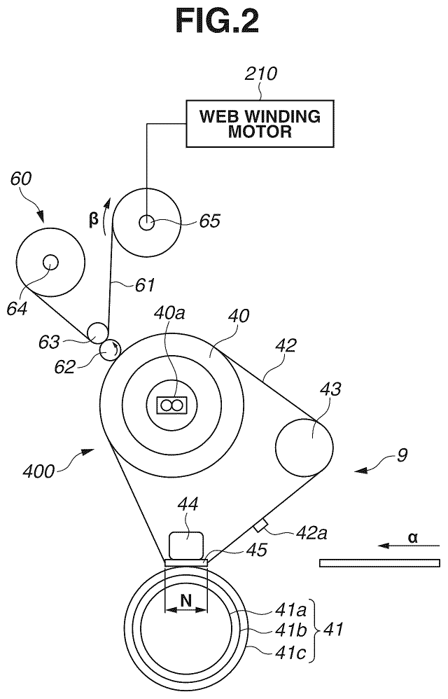

Next, the fixing device 9 will be described with reference to FIG. 2. The fixing device 9 according to the present embodiment is a belt heating type fixing device. In FIG. 2, the recording material S is conveyed from right to left in the conveyance direction indicated by an arrow a. The fixing device 9 serving as a fixing unit includes a rotary heating unit 400 and a pressure roller 41. The rotary heating unit 400 includes a heating roller 40, a fixing belt 42, a steering roller 43, a stay 44, a fixing pad 45, and a belt temperature detection sensor 42a.

The fixing belt 42 is stretched around the heating roller 40, the steering roller 43, and the stay 44, which are arranged inside the fixing belt 42.

The heating roller 40 is cylindrically formed by a metal such as aluminum or stainless steel.

In the present embodiment, the heating roller 40 is made of an aluminum pipe having an outer diameter of 80 millimeters (mm).

A halogen heater 40a for heating the fixing belt 42 is installed inside the heating roller 40. The heating roller 40 is heated by the halogen heater 40a, and the fixing belt 42 is heated by the heating roller 40 that has been heated by the halogen heater 40a. The belt temperature detection sensor 42a detects the temperature of the heated fixing belt 42. The temperature of the halogen heater 40a is controlled based on the temperature detection result acquired by the belt temperature detection sensor 42a so that the temperature of the fixing belt 42 is adjusted to a target temperature. However, the present embodiment is not limited to the use of the halogen heater 40a, and, for example, an electromagnetic induction heater (IH) may be used to heat the heating roller 40 and, consequently, the fixing belt 42.

The fixing belt 42 serving as a first rotating member has thermal conductivity and heat resistance. For example, the fixing belt 42 is formed into a thin-walled cylindrical shape having an inner diameter of 120 mm. In the present embodiment, the fixing belt 42 has a three-layer structure including a base layer, an elastic layer formed on the outer side of the base layer, and a release layer formed on the outer side of the elastic layer. The base layer has a thickness of approximately 60 micrometers (μm), and polyimide resin (PI) is used as its material. The elastic layer has a thickness of 300 μm, and silicon rubber is used as its material. The release layer has a thickness of 30 μm, and tetrafluoroethylene-perfluoroalkoxyethylene copolymer resin (PFA), which is a fluororesin, is used as its material. The fixing belt 42 is driven to rotate as a follower when the pressure roller 41, which is described below, comes into contact with the fixing belt 42 and is rotationally driven.

The fixing pad 45 is arranged to face the pressure roller 41 with the fixing belt 42 interposed therebetween, and is pressed against the pressure roller 41 via the fixing belt 42. A fixing nip portion N for fixing a toner image onto the recording material S while holding and conveying the recording material S is formed at a contact portion between the fixing belt 42 and the pressure roller 41. A lubricating sheet or a lubricant agent (e.g., silicon oil) is interposed between the fixing belt 42 and the fixing pad 45 so that the fixing belt 42 and the fixing pad 45 can smoothly slide against each other. Liquid crystal polymer (LCP) is used as the material of the fixing pad 45, and the fixing pad 45 is adhered to the stay 44 that is provided in a non-rotatable manner on the inner side of the fixing belt 42. The stay 44 is a rigid member having high rigidity, formed of, for example, stainless steel, and is an elongated member that supports the fixing pad 45 in a width direction intersecting with the conveyance direction (indicated by an arrow a) of the recording material S.

The pressure roller 41 serving as a second rotating member forms the fixing nip portion N by applying pressure to the fixing pad 45. The pressure roller 41 includes a cylindrically-shaped aluminum core metal 41a, an elastic layer 41b having a thickness of 1 mm arranged on the outer side of the core metal 41a, and a release layer 41c arranged on the outer side of the elastic layer 41b to enhance releasability from toner. The pressure roller 41 pressurizes the fixing belt 42 toward the fixing pad 45. In the present embodiment, the pressure roller 41 forms the fixing nip portion N having a length of 24 mm in the conveyance direction by pressurizing the fixing belt 42 with a total pressure of 784 N (approximately 80 kg).

The pressure roller 41 rotates by being driven by a drive motor 50.

### <Cleaning Unit>

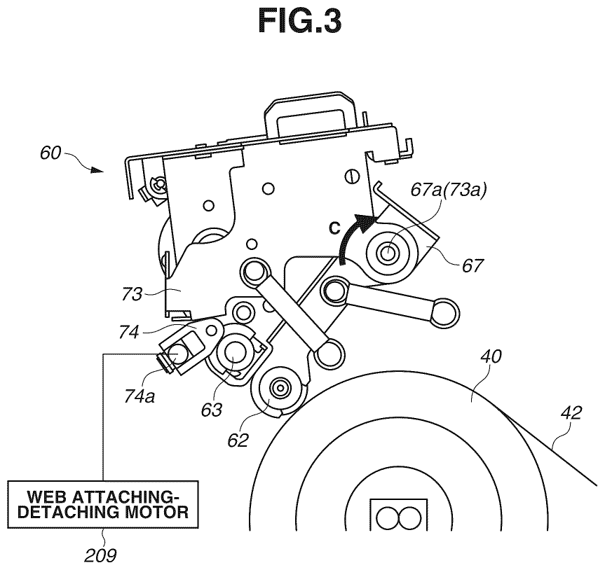

Next, the cleaning unit 60 will be described with reference to FIGS. 2 and 3. The cleaning unit 60 serving as a cleaning unit is provided to remove offset toner remaining on the surface of the fixing belt 42 that has passed through the fixing nip portion N. In a case where an excessive amount of heat is applied to the recording material S when the toner image is fixed by the fixing device 9, a phenomenon called “hot offset” occurs. In this phenomenon, part of the toner on the surface of the recording material S melts excessively, and the over-melted toner is adhered to the fixing belt 42 that has passed through the fixing nip portion N. On the contrary, in a case where the amount of heat applied to the recording material S is not sufficient, a phenomenon called “cold offset” occurs. In this phenomenon, part of the toner on the surface of the recording material S does not melt, and the unmelted toner is adhered to the fixing belt 42 that has passed through the fixing nip portion N.

An amount of heat necessary to fix the toner image to the recording material S is different depending on the basis weight of the recording material S, and the necessary amount of heat increases when the basis weight of the recording material S increases. Therefore, in a case where an image forming job in which images are continuously formed on recording materials S having different basis weights is to be executed, it is desirable that the temperature of the fixing belt 42 (hereinafter, referred to as “fixing temperature”) be changed as appropriate according to the basis weight of the recording material S. However, in order to change the fixing temperature, it is necessary to temporarily stop the image forming job which is being executed, so that the productivity of the image forming apparatus 100 is lowered. Therefore, in order not to reduce the productivity of the image forming apparatus 100, it is conceivable to continuously execute image forming on recording materials S having different basis weights without temporarily stopping the image forming job by feeding the recording material S, such as thin paper, having a relatively small basis weight while maintaining the fixing temperature used when feeding a recording material S, such as thick paper, having a large basis weight.

However, in a case where an image is formed on the thin paper while maintaining the fixing temperature for thick paper, the above-described hot offset occurs because an amount of heat greater than an amount of heat necessary to fix the toner image is applied to the thin paper. If toner remains adhered to the fixing belt 42 due to the hot offset, there is a risk that the toner may adhere to a subsequent recording material S and degrade the quality level of the toner image formed on the subsequent recording material S. Similarly, even when cold offset occurs, if toner remains adhered to the fixing belt 42, there is a risk that the toner may transfer to a subsequent recording material S, thereby degrading the quality level of the toner image formed on the subsequent recording material S. The cleaning unit 60 is provided in order to suppress image defects caused by toner (referred to as “offset toner”) adhering to the fixing belt 42 due to the above-described hot offset or the cold offset.

As illustrated in FIG. 2, the cleaning unit 60 includes a web (cleaning web) 61, a cleaning roller 62, a web roller 63, a web feeding mechanism 64, and a web winding mechanism 65. The cleaning roller 62 is driven to rotate by being in contact with the surface of the fixing belt 42. The offset toner on the fixing belt 42 is maintained in a molten state by the heat from the halogen heater 40a. The cleaning roller 62 serving as an intermediate rotating member is formed of stainless steel (SUS 303) having a relatively higher affinity for toner in a molten state than the release layer formed on the surface of the fixing belt 42. Therefore, the offset toner easily transfers to the cleaning roller 62 from the fixing belt 42.

The offset toner transferred to the cleaning roller 62 is removed from the cleaning roller 62 by the web 61, such as an unwoven fabric. The web roller 63 serving as a pressing rotating member presses the web 61 against the cleaning roller 62 to bring the web 61 into contact with the cleaning roller 62. Therefore, the web 61 is rubbed against the cleaning roller 62. Since the web 61 and the cleaning roller 62 rub against each other over a wide area by the web roller 63, the toner removal capability of the web 61 can be improved. Because the cleaning roller 62 rotates following the fixing belt 42, the offset toner on the cleaning roller 62 is removed at a portion where the cleaning roller 62 comes into contact with the web 61.

The web 61 having a total length of, for example, 40 m and pre-wound in a roll is mounted on the web feeding mechanism 64. One end of the web 61 is mounted on the web winding mechanism 65 serving as a winding unit so as to be windable. The web winding mechanism 65 is rotationally driven by a web winding motor 210 so that the web 61 is wound from the web feeding mechanism 64 in the direction of arrow B in a roll form. The web feeding mechanism 64 feeds out the web 61 in the direction of arrow B in tandem with the winding of the web winding mechanism 65. In other words, the web is wound by the web winding mechanism 65 by an amount equivalent to the amount of web fed out from the web feeding mechanism 64 (referred to as “web conveyance amount”). In this way, a portion of the web 61 being in contact with the cleaning roller 62 is wound in the direction of arrow B, so that a new portion of the web 61 comes in contact with the cleaning roller 62 before the web 61 becomes saturated with offset toner.

The web winding mechanism 65 is rotationally driven by the web winding motor 210, which serves as a driving unit, each time fixing operation is executed on a predetermined number of recording materials S. For example, the web winding mechanism 65 winds the web 61 in the direction of arrow B at a web conveyance amount of 0.08 mm per sheet of recording medium (predetermined conveyance amount). For example, in a case where the web winding mechanism 65 is operated once each time fixing operation is executed on one sheet of recording material S, the web conveyance amount per operation is 0.08 mm (0.08×1). Alternatively, the web winding mechanism 65 may be operated once each time fixing operation is executed on, for example, ten sheets of recording materials S. In this case, the web conveyance amount per operation is 0.8 mm (0.08×10).

However, in the present embodiment, the web conveyance amount per operation, which is the amount of web wound by one operation of the web winding mechanism 65, is changed based on conveyance amount information related to the web conveyance amount corresponding to the melting characteristics of the toner contained in the development device 1d after replacement, when the development device 1d is replaced. Further, each time replenishment toner is supplied from the toner bottle 7d, the web conveyance amount per operation is changed based on conveyance amount information related to the web conveyance amount corresponding to the melting characteristics of the replenishment toner contained in the toner bottle 7d. Details of such changes in the web conveyance amount per operation will be described below.

### <Contact-Separation Mechanism>

The cleaning unit 60 is provided to be movable between a contact position where the cleaning roller 62 is in contact with the fixing belt 42 and a separation position where the cleaning roller 62 is not in contact with the fixing belt 42. The contact-separation mechanism which moves the cleaning unit 60 will be described with reference to FIG. 3. As illustrated in FIG. 3, the cleaning unit 60 includes a web arm 73 for supporting the web roller 63, an attaching-detaching cam 74 in contact with the web arm 73, and an intermediate supporting arm 67 for supporting the cleaning roller 62.

The attaching-detaching cam 74 is rotated about a rotation fulcrum 74a by a web attaching-detaching motor 209.

When the attaching-detaching cam 74 is rotated, the web arm 73, which supports the web roller 63, rotates about a rotation fulcrum 73a, and, as a result, the web 61 and the web roller 63 are separated from the fixing belt 42. Further, with the rotation of the attaching-detaching cam 74, the intermediate supporting arm 67, which supports the cleaning roller 62, rotates about a rotation fulcrum 67a in the direction of arrow C. With this rotation, the cleaning roller 62 is separated from the fixing belt 42. The cleaning roller 62 comes into contact with the fixing belt 42 when the attaching-detaching cam 74 is rotated in a direction opposite to the direction of arrow C by the web attaching-detaching motor 209.

### <Control Unit>

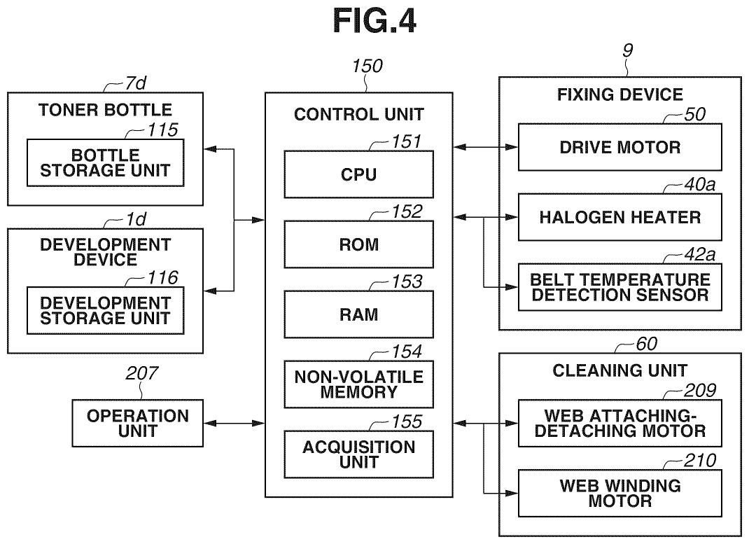

Next, a control unit of the image forming apparatus 100 according to the present embodiment will be described with reference to FIG. 4. A control unit 150 which generally controls each of the units is provided in the image forming apparatus 100 (see FIG. 1). Although various devices other than those devices illustrated in FIG. 4 are connected to the control unit 150, description and illustration of such devices are omitted since they are not essential to the gist of the disclosure.

The control unit 150 includes a central processing unit (CPU) 151, a read only memory (ROM) 152, a random access memory (RAM) 153, and a non-volatile memory 154. The CPU 151 controls each of the units while reading a program stored in the ROM 152. The RAM 153 and the non-volatile memory 154 store working data and input data including image data. Based on execution of the program, the CPU 151 refers to the data stored in the RAM 153 and the non-volatile memory 154 to execute various types of control, such as image forming control and toner replenishment control. An operation unit 207 serving as an interface, which allows a user and an external device to communicate with or to access the apparatus, is connected to the control unit 150. The user can input various settings, an instruction to execute an image forming job and the like to the image forming apparatus 100 via the operation unit 207.

The control unit 150 monitors and controls the states of various units of the image forming apparatus 100 and supervises the command system among the units, and can control the toner image development operation executed by the development device 1d, the toner image fixing operation executed by the fixing device 9, the replenishment operation for supplying replenishment toner from the toner bottle 7d, and the cleaning operation executed by the cleaning unit 60. In the present embodiment, when the cleaning operation is executed by the cleaning unit 60, the control unit 150 executes the winding operation of the web 61 by the web winding mechanism 65 in accordance with the web conveyance amount per operation stored in the non-volatile memory 154.

As described above, the development device 1d is configured such that the toner bottle 7d containing replenishment toner can be attached to and detached from the development device 1d. Toner contained in the development device 1d is consumed each time an electrostatic latent image formed on the photosensitive drum 3d is developed into a toner image. At this time, the control unit 150 estimates the amount of toner the development device 1d has used for development (referred to as “toner consumption amount”). Then, in a case where the toner consumption amount reaches a predetermined amount, the control unit 150 executes a replenishment operation for supplying replenishment toner to the development device 1d from the toner bottle 7d. At this time, the amount of replenishment toner supplied from the toner bottle 7d is substantially equal to the estimated toner consumption amount. Accordingly, each time the replenishment toner is supplied from the toner bottle 7d, the amount of toner contained in the development device 1d is restored to approximately the initial amount.

In the present embodiment, the control unit 150 estimates the toner consumption amount by employing a video counter method. The control unit 150 includes a video counter (not illustrated). The video counter calculates the sum of the densities of individual pixels included in an image corresponding to one page (hereinafter referred to as “video counter value”) based on the input image data. The control unit 150 calculates the amount of toner consumed by the development device 1d by using the video counter value calculated by the video counter. The non-volatile memory 154 stores the above-described video counter value and the toner consumption amount calculated from the video counter value. Although the case where the video counter method is employed has been described as an example, the present embodiment is not limited thereto, and a toner remaining amount detection method that detects the amount of toner consumed by the development device 1d using a magnetic permeability sensor or the like may be employed.

In the present embodiment, a development storage unit 116 is provided in the development device 1d. A predetermined web conveyance correction amount 1 (fixed value) calculated in advance based on the melting characteristics of toner contained in a new development device 1d is stored in the development storage unit 116, which serves as a first storage unit. A bottle storage unit 115 is provided in the toner bottle 7d. A predetermined web conveyance correction amount 2 (fixed value) calculated in advance based on the melting characteristics of toner contained in the toner bottle 7d is stored in the bottle storage unit 115, which serves as a second storage unit. The web conveyance correction amount 1 is stored in the development storage unit 116 when toner is loaded into the development device 1d, and the web conveyance correction amount 2 is stored in the bottle storage unit 115 when replenishment toner is loaded into the toner bottle 7d. The web conveyance correction amounts 1 and 2 are examples of conveyance amount information related to the web conveyance amount.

An acquisition unit 155 can acquire programs and data stored in the ROM 152, the RAM 153, and the non-volatile memory 154, the initial conveyance amount and the web conveyance correction amount 1 stored in the development storage unit 116, and the web conveyance correction amount 2 stored in the bottle storage unit 115.

The development storage unit 116 and the bottle storage unit 115 may be non-volatile storage memories, but are not limited to non-volatile memories. The web conveyance correction amount 1 and the web conveyance correction amount 2 may alternatively be read in a configuration using an Integrated Circuit (IC) tag such as a Radio Frequency Identification (RFID) or a format such as a Quick Response (QR) code®.

<Relationship between Fixing Temperature and Offset Toner Amount>

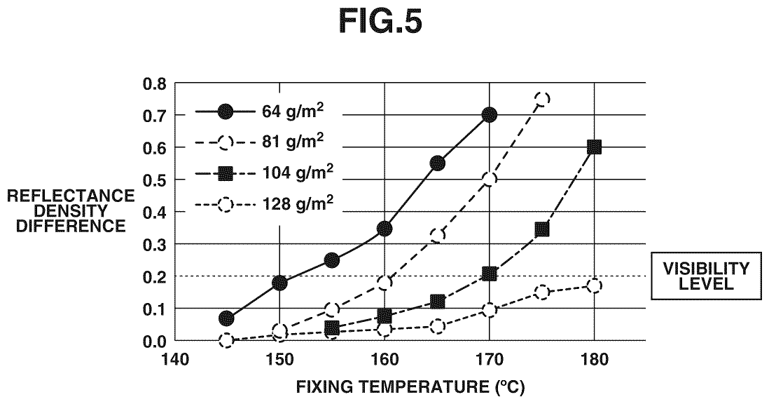

The relationship between the fixing temperature and the offset toner amount will now be described. The inventors conducted an experiment to investigate the relationship between the fixing temperature of the fixing belt 42 and the amount of offset toner adhering to the fixing belt 42 due to hot offset. FIG. 5 is a graph illustrating the relationship between the fixing temperature and the hot offset toner amount for each of recording materials S having different basis weights, acquired as a result of the experimental. In the experiment, the conveyance speed of the recording material S in the fixing device 9 was set to 300 mm/sec, and the fixing temperature was changed in increments of 5° C. within a range of 145° C. to 180° C., while passing the recording material S having an unfixed toner image through the fixing device 9. The recording materials S having basis weights of 64 g/m², 81 g/m², 104 g/m², and 128 g/m² were used.

In FIG. 5, a reflectance density difference, which varies in proportion to the offset toner amount was used as an index representing the amount of offset toner adhering to the fixing belt 42. The reflectance density difference was quantified by measuring, with a reflection densitometer, the reflectance densities of a toner re-adhesion portion and a white background portion on the recording material S, and calculating the difference between them. It is considered that the amount of offset toner becomes greater when the value of the reflectance density difference is greater. A “TC-6MC-D” manufactured by Tokyo Denshoku Co., Ltd. was used as the reflectance densitometer.

The visibility level illustrated in FIG. 5 (i.e., the reflectance density difference of 0.2 or less) is a level at which a portion where the offset toner has re-adhered to a subsequent recording material S can visually be recognized. There is a risk that image defects occur in the subsequent recording material S in a case where the amount of offset toner exceeds the visibility level. Therefore, in the image forming operation, it is desirable that the reflectance density difference does not exceed 0.2. As illustrated in FIG. 5, the reflectance density difference becomes greater when the temperature of the fixing device 9 is higher. Furthermore, the reflectance density difference is greater when the basis weight of the recording material S is smaller.

As can be understood from the experimental result illustrated in FIG. 5, image defects caused by hot offset can be suppressed by setting the target temperature to 150° C. or lower when the recording material S having a basis weight of 64 g/m² is fed through the fixing device 9 because the reflectance density difference falls below the visibility level. Similarly, when the recording materials S having basis weights of 81 g/m², 104 g/m², and 128 g/m² are fed through the fixing device 9, image defects caused by hot offset can be suppressed by setting the target temperatures to 160° C. or lower, 165° C. or lower, and 170° C. or lower, respectively.

The inventors further conducted an experiment to examine the relationship between the fixing temperature of the fixing belt 42 and the amount of cold-offset toner adhering to the fixing belt 42 due to cold offset. Table 1 illustrates the relationship between the fixing temperature and the amount of cold-offset toner for each of recording materials S having different basis weights, as acquired from the experimental results. In the experiment, the conveyance speed of a recording material S at the fixing device 9 was set to 300 mm/sec, and the recording material S on which an unfixed toner image had been formed was fed through the fixing device 9 while changing the fixing temperature in increments of 5° C. within a range from 150° C. to 180° C. The recording materials S having the basis weights of “64 g/m²,” “81 g/m²,” “104 g/m²,” “300 g/m²,” and “350 g/m²” were used. In Table 1, the symbol “∘” (OK) indicates that the amount of offset toner did not exceed the visibility level or that no cold offset occurred, and the symbol “×” (NG) indicates that the amount of offset toner exceeded the visibility level.

TABLE 1

| Fixing | | | | | | | | |
|---|---|---|---|---|---|---|---|---|
| Temperature | | | | | | | | |
| (° C.) | | 150 | 155 | 160 | 165 | 170 | 175 | 180 |
| 64 | g/m² | ∘ | ∘ | ∘ | ∘ | ∘ | ∘ | ∘ |
| 81 | g/m² | x | x | ∘ | ∘ | ∘ | ∘ | ∘ |
| 104 | g/m² | x | x | x | ∘ | ∘ | ∘ | ∘ |
| 300 | g/m² | x | x | x | x | ∘ | ∘ | ∘ |
| 350 | g/m² | x | x | x | x | x | x | ∘ |

As understood from the experimental result illustrated in Table 1, image defects caused by cold offset can be suppressed by setting the target temperature to “150° C.” or higher when the recording material S having a basis weight of “64 g/m²” is fed through the fixing device 9. Similarly, when the recording materials S having basis weights of “81 g/m²,” “104 g/m²,” “300 g/m²,” and “350 g/m²” are fed through the fixing device 9, image defects caused by cold offset can be suppressed by setting the target temperatures to “160° C.” or higher, “165° C.” or higher, “170° C.” or higher, and “180° C.” or higher, respectively.

In view of the experimental results in FIG. 5 and Table 1, Table 2 shows the target temperature at which the reflectance density difference does not exceed 0.2, i.e., the target temperature at which the amount of offset toner exceeds the visibility level, for each of the recording materials S having different basis weights. Specifically, the target temperature is “150° C.” when the basis weight is from “64 g/m² to 75 g/m²,” the target temperature is “160° C.” when the basis weight is from “76 g/m² to 90 g/m²,” the target temperature is “165° C.” when the basis weight is from “91 g/m² to 105 g/m²,” the target temperature is “170° C.” when the basis weight is from “106 g/m² to 300 g/m²,” and the target temperature is “180° C.” when the basis weight is from “301 g/m² to 350 g/m².” In the experiment, the reflectance density difference when the recording material S having a basis weight ranging from 301 g/m² to 350 g/m² was fed at the temperature of 180° C. was not measured. Therefore, in Table 2, the reflectance density difference for the recording material having a basis weight ranging from “301 g/m² to 350 g/m²” is indicated with “-”. No offset toner occurs under the conditions illustrated in Table 2, and thus, it is possible to suppress occurrence of image defects in subsequent recording materials S.

TABLE 2

| | Basis Weight (g/m²) of | | | | |
|---|---|---|---|---|---|
| | Recording Material | | | | |
| | 64- | 76- | 91- | 106- | 301- |
| | 75 | 90 | 105 | 300 | 350 |
| Target Temperature (° C.) | 150 | 160 | 165 | 170 | 180 |
| Reflectance Density | 0.18 | 0.18 | 0.12 | 0.10 | — |
| Difference | | | | | |

In such a case, for example, when an image forming job in which the recording material S having a basis weight of 64 g/m² and the recording material S having a basis weight of 300 g/m² are mixed is to be executed, the fixing temperature of the fixing device 9 is changed from 150° C. to 170° C. (or from 170° C. to 150° C.) in accordance with the target temperatures illustrated in Table 2. In order to change the fixing temperature, the image forming job which is being executed needs to be stopped temporarily. In the present embodiment, downtime caused by switching the fixing temperature is reduced by keeping the target temperature constant regardless of the basis weight of the recording material S. For example, the target temperature is set to 170° C. regardless of the basis weight of the recording material S.

### <Web Conveyance Amount Per Operation>

Even in a case where the target temperature is kept constant regardless of the basis weight of the recording material S, offset toner may occur depending on the basis weight of the recording material S, and therefore, a cleaning operation by the cleaning unit 60 is performed. As described above, when the cleaning operation is executed by the cleaning unit 60, the control unit 150 executes the winding operation of the web 61 by the web winding mechanism 65 in accordance with the web conveyance amount per operation stored in the non-volatile memory 154.

Herein, the amount of offset toner adhering to the fixing belt 42 is changed not only by the fixing temperature of the fixing belt 42, as described above, but also by the melting characteristics of toner contained in the development device 1d. In the present embodiment, the melting characteristics of toner that results in a small amount of offset toner are such that the viscosity is low, the toner fracture strength is small, the wax content is large, and the external additive coverage is small (this is referred to herein as low toner melting characteristics for convenience). The melting characteristics of toner that results in a large amount of offset toner are such that the viscosity is high, the toner fracture strength is large, the wax content is small, and the external additive coverage is large (this is referred to herein as high toner melting characteristics for convenience). In other words, in a case where the toner melting characteristics are high, the amount of offset toner adhering to the fixing belt 42 increases.

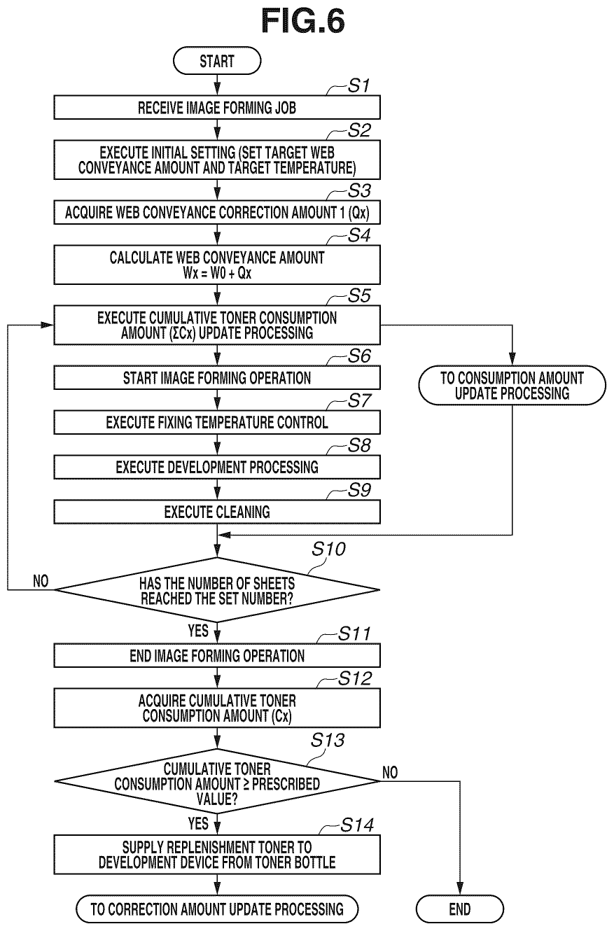

Therefore, in the present embodiment, offset toner can be removed from the fixing belt 42 without wasting the web 61 by changing the web conveyance amount per operation depending on the melting characteristics of toner contained in the development device 1d. Hereinafter, the following description will be given with reference to FIG. 4 and using FIGS. 6 to 10.

FIG. 6 is a flowchart illustrating processing from when the image forming apparatus 100 receives an execution instruction for an image forming job until the image forming job is completed. This processing is executed by the control unit 150 (specifically, the CPU 151). As illustrated in FIG. 6, in step S1, the control unit 150 receives an instruction for executing an image forming job. In step S2, the control unit 150 executes initial processing. Through the initial processing, the control unit 150 sets the target temperature to, for example, 170° C. regardless of the basis weight of the recording material S, and stores, in the non-volatile memory 154, an initial conveyance amount that the acquisition unit 155 has acquired from the development device 1d, as a target web conveyance amount (W0). In step S3, the control unit 150 further stores, in the non-volatile memory 154, a web conveyance correction amount 1 (Qx), which the acquisition unit 155 has acquired from the development device 1d.

As the conveyance amount information related to the web conveyance amount according to the melting characteristics of the contained toner, any one of combinations of “web conveyance correction amount 1” and “initial conveyance amount” as illustrated in Table 3 is stored in advance in the development storage unit 116 of the development device 1d. For example, in a case where “Toner A” having melting characteristics higher than those of “Toner C” is contained in the development device 1d, a web conveyance correction amount 1 of “0.010 mm/sheet”, and an initial conveyance amount of “0.070 mm/sheet” are stored in advance in the development storage unit 116. In a case where the development device 1d is replaced with a new development device 1d, the control unit 150 changes (rewrites) the target web conveyance amount (W0) and the web conveyance correction amount 1 (Qx) stored in the non-volatile memory 154 based on the initial conveyance amount and the web conveyance correction amount 1 stored in the development storage unit 116 of the replaced development device 1d, which are acquired by the acquisition unit 155.

TABLE 3

| Toner Melting Characteristics | Toner A | Toner B | Toner C |
|---|---|---|---|
| Conveyance Correction Amount 1 | 0.010 | 0.005 | 0 |
| Initial Conveyance Amount | 0.070 | 0.075 | 0.080 |

In step S4, in accordance with the web conveyance correction amount 1 (Qx) and the target web conveyance amount (W0) stored in the non-volatile memory 154, the control unit 150 calculates a web conveyance amount (Wx) per operation. The web conveyance correction amount 1 (Qx) is a first conveyance correction amount used to change the web conveyance amount (Wx) per operation by correcting the target web conveyance amount (W0), which is a predetermined conveyance amount determined in advance. The web conveyance amount (Wx) is determined according to the following equation 1.

$${W}_{X} = W 0 + {Q}_{X} \qquad Equation 1$$

Wx: Web Conveyance Amount (mm/sheet)
W0: Target Web Conveyance Amount (mm/sheet)
Qx: Web Conveyance Correction Amount 1 (mm/sheet)

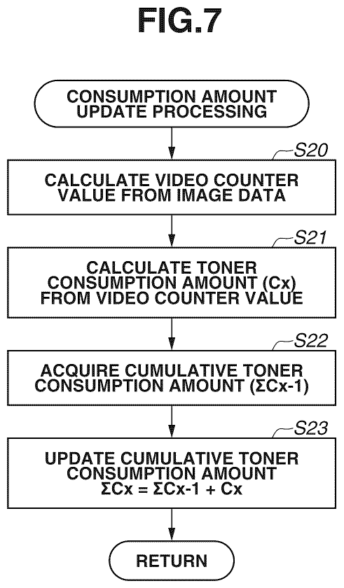

In step S5, the control unit 150 executes consumption amount update processing to update a cumulative toner consumption amount (ΣCx). The consumption amount update processing is executed for each sheet of the recording material S in parallel with the below-described image forming operation in steps S6 to S10. The consumption amount update processing is illustrated in FIG. 7. As illustrated in FIG. 7, in step S20, the control unit 150 calculates a video counter value based on the input image data. In step S21, based on the calculated video counter value, the control unit 150 calculates a toner consumption amount (Cx), i.e., an amount of toner to be used (consumed) by the development device 1d in order to develop a toner image on the current recording material S. Next, in step S22, the control unit 150 acquires a cumulative toner consumption amount (ΣCx−1), consumed up to the previous sheet of the recording material S, which is stored in the non-volatile memory 154. In step S23, the control unit 150 updates the cumulative toner consumption amount to the cumulative toner consumption amount (ΣCx) including the toner consumption amount (Cx) consumed for the current recording material S according to the following equation 2.

$$Σ Cx = Σ Cx - 1 + Cx \qquad Equation 2$$

ΣCx: Cumulative Toner Consumption Amount (g) including the Toner Consumption Amount of the Current Recording Material S
ΣCx−1: Cumulative Toner Consumption Amount (g) up to the Toner Consumption Amount for the Previous Recording Material S
Cx: Toner Consumption Amount (g) used (consumed) for the Current Recording Material S

Returning to FIG. 6, in step S6, the control unit 150 starts the image forming operation after calculating the web conveyance amount (Wx). At this time, in step S7, the control unit 150 executes fixing temperature control at a predetermined timing. Thereafter, in step S8, the control unit 150 executes development processing. In the development processing, the development device 1d develops the electrostatic latent image formed on the photosensitive drum 3d into a toner image using toner. Accordingly, toner contained in the development device 1d is consumed each time the development processing is executed. In step S9, the control unit 150 executes cleaning of the fixing belt 42 by the cleaning unit 60 each time the recording material S passes through the fixing device 9. After executing cleaning of the fixing belt 42 by the cleaning unit 60, the control unit 150 drives the web winding motor 210 to execute the winding operation of the web 61 in accordance with the web conveyance amount (Wx) stored in the non-volatile memory 154.

Then, the control unit 150 repeatedly executes the development operation (development processing) of a toner image by the development device 1d, the fixing operation of a toner image by the fixing device 9, and the cleaning operation by the cleaning unit 60, and, in step 10, determines whether the number of sheets of the recording materials S to be processed through the image forming operation in the current image forming job has been reached. In a case where the number of sheets of the recording material S to be processed through the image forming operation in the current image forming job has not been reached (NO in step S10), the processing returns to step S5, and the control unit 150 repeatedly executes the consumption amount update processing in step S5 and the image forming operation in steps S6 to S10. In a case where the number of sheets of the recording material S to be processed through the image forming operation in the current image forming job has been reached (YES in step S10), the processing proceeds the processing to step S11, and in step S11, the control unit 150 ends the image forming operation.

After ending the image forming operation, in step S12, the control unit 150 acquires the cumulative toner consumption amount (ΣCx) stored in the non-volatile memory 154 as a result of the above-described consumption amount update processing. Then, in step S13, the control unit 150 determines whether the cumulative toner consumption amount (ΣCx) is equal to or greater than a predetermined value. In a case where the cumulative toner consumption amount (ΣCx) is less than the predetermined value (NO in step S13), the processing ends. On the other hand, in a case where the cumulative toner consumption amount (ΣCx) is equal to or greater than the predetermined value (YES in step S13), the processing proceeds to step S14. In step S14, the control unit 150 executes a replenishment operation to supply replenishment toner to the development device 1d from the toner bottle 7d. At this time, the control unit 150 supplies an amount of replenishment toner corresponding to the cumulative toner consumption amount (ΣCx) from the toner bottle 7d. Thereafter, the processing proceeds to the correction amount update processing for updating the web conveyance correction amount 1 (Qx) stored in the non-volatile memory 154.

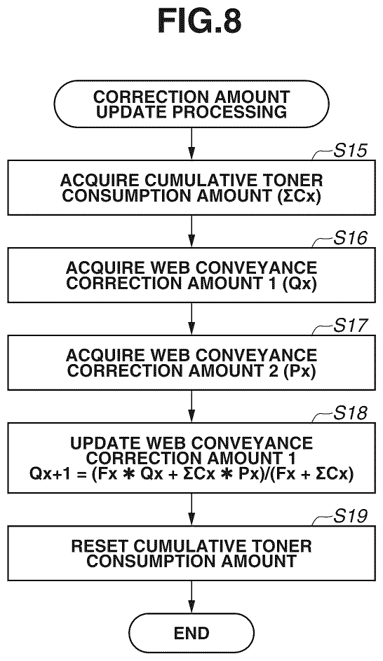

The correction amount update processing is illustrated in FIG. 8. As illustrated in FIG. 8, in step S15, the control unit 150 acquires the cumulative toner consumption amount (ΣCx) stored in the non-volatile memory 154, and, in step S16, the control unit 150 acquires the web conveyance correction amount 1 (Qx) stored in the non-volatile memory 154. In step S17, the control unit 150 further acquires a web conveyance correction amount 2 (Px), which serves as a second conveyance correction amount, stored in the bottle storage unit 115 of the toner bottle 7d. Then, in step S18, the control unit 150 updates the web conveyance correction amount 1 (Qx+1) according to the following equation 3, using the acquired cumulative toner consumption amount (ΣCx), the acquired web conveyance correction amount 1 (Qx), the acquired web conveyance correction amount 2 (Px), and the toner amount (Fx) contained in the development device 1d. The control unit 150 rewrites the web conveyance correction amount 1 (Qx) stored in the non-volatile memory 154 to the updated web conveyance correction amount (Qx+1) and stores the rewritten amount.

$$Qx + 1 = ( Fx \times Qx + Σ Cx \times Px ) / ( Fx + Σ Cx ) \qquad Equation 3$$

Qx+1: Web Conveyance Correction Amount 1 (mm/sheet) after update
Qx: Web Conveyance Correction Amount 1 (mm/sheet) before update
Px: Web Conveyance Correction Amount 2 (mm/sheet)
ΣCx: Cumulative Toner Consumption Amount (g)
Fx: Toner Amount (g) contained in Development Device 1d

In step S19, the control unit 150 resets the cumulative toner consumption amount (ΣCx) to “0,” and ends the series of processing including the correction amount update processing following the processing illustrated in FIG. 6 described above. In the present embodiment, the cumulative toner consumption amount (ΣCx) is reset to 0 since an amount of replenishment toner equal to the cumulative toner consumption amount (ΣCx) is supplied to the development device 1d from the toner bottle 7d. However, the present embodiment is not limited thereto. For example, in a case where the cumulative toner consumption amount (ΣCx) and the amount of replenishment toner supplied to the development device 1d from the toner bottle 7d are different from each other, a difference between the cumulative toner consumption amount (ΣCx) and the amount of supplied replenishment toner may be calculated and stored as the cumulative toner consumption amount (ΣCx).

As described above, in the present embodiment, the cumulative toner consumption amount (ΣCx) stored in the non-volatile memory 154 is updated by using the web conveyance correction amount 2 (Px) stored in the bottle storage unit 115 of the toner bottle 7d. This is because the melting characteristics of toner contained in the development device 1d change according to the amount of replenishment toner supplied from the toner bottle 7d, in a case where the melting characteristics of toner contained in the development device 1d are different from the melting characteristics of replenishment toner contained in the toner bottle 7d.

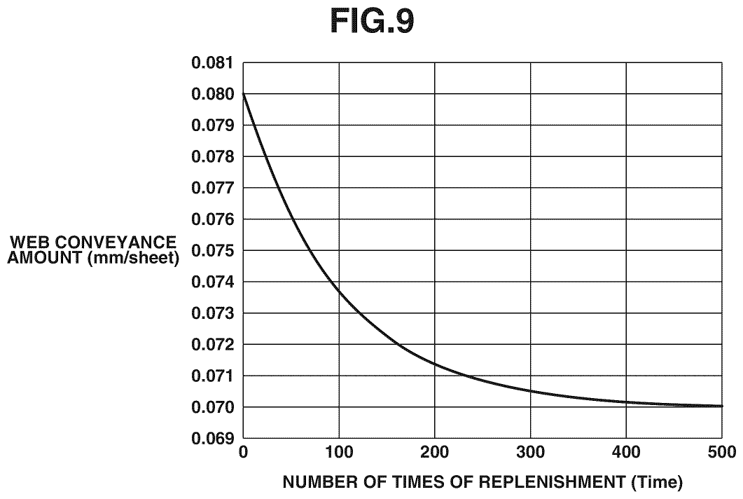

FIG. 9 is a graph illustrating a transition of a web conveyance amount (Wx) in a case where replenishment of toner from the toner bottle 7d to the development device 1d is repeated from 0 to 500 times. Here, an example of a transition of the web conveyance amount (Wx) is provided in which the target web conveyance amount (W0) is 0.08 mm/sheet, the web conveyance correction amount 1 (Qx) when the number of times of toner replenishment is 0 times is 0.00 mm/sheet, the web conveyance correction amount 2 (Px) is −0.01 mm/sheet, the cumulative toner consumption amount (ΣCx) is 0.2 g, and the toner amount (Fx) contained in the development device 1d at the time of toner replenishment is 19.8 g. Further, in this example, the melting characteristics of replenishment toner contained in the toner bottle 7d are lower than the melting characteristics of toner contained in the development device 1d.

In the present embodiment, the target web conveyance amount (W0), the web conveyance correction amount 2 (Px), the cumulative toner consumption amount (ΣCx), and the toner amount (Fx) contained in the development device 1d are constant, and only the web conveyance correction amount 1 (Qx) changes as the number of times of replenishment increases. Therefore, as illustrated in FIG. 9, the web conveyance amount (Wx) is sequentially updated to 0.07 mm/sheet from 0.08 mm/sheet. In other words, the ratio of the replenishment toner having lower melting characteristics increases in the toner contained in the development device 1d as the number of times of replenishment of the replenishment toner increases, so that the melting characteristics of the toner contained in the development device 1d after replenishment become lower than the melting characteristics before replenishment. In this case, since the amount of offset toner adhering to the fixing belt 42 decreases, the offset toner can be removed from the fixing belt 42 even if the web conveyance amount (Wx) per operation is reduced from 0.08 mm/sheet to 0.07 mm/sheet.

Table 4 illustrates a reflectance density difference for each basis weight of the recording material S when the target temperature is “170° C.” and cleaning of the fixing belt 42 by the cleaning unit 60 is not executed. As illustrated in Table 4, when the basis weight of the recording material S is from “91 g/m² to 105 g/m²,” the reflectance density difference exceeds “0.2,” which corresponds to the visibility level. Therefore, the cleaning operation is executed by the cleaning unit 60 to remove offset toner from the fixing belt 42. In this way, since offset toner is removed before it adheres to a subsequent recording material S, image defects caused by the offset toner can be suppressed.

TABLE 4

| | Basis Weight (g/m²) of | | | | |
|---|---|---|---|---|---|
| | Recording Material | | | | |
| | 64- | 76- | 91- | 106- | 301- |
| | 75 | 90 | 105 | 300 | 350 |
| Target Temperature (° C.) | 170 | 170 | 170 | 170 | 170 |
| Reflectance Density | 0.70 | 0.50 | 0.21 | 0.10 | — |
| Difference | | | | | |

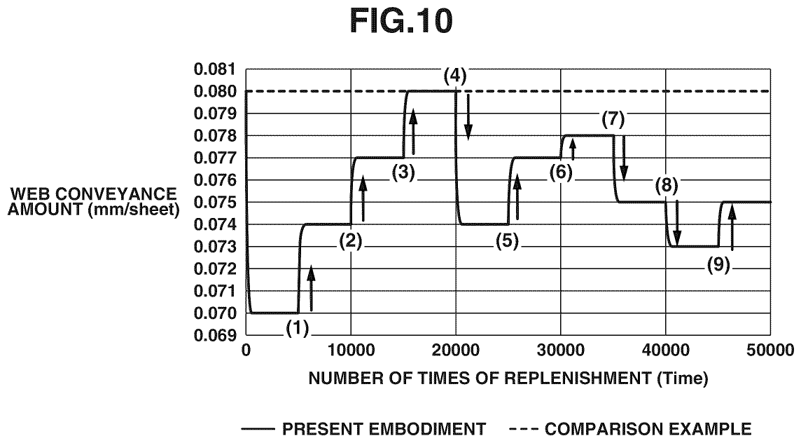

FIG. 10 illustrates a transition of the web conveyance amount when replacement of the toner bottle 7d is repeated nine times, in the present embodiment in which the web conveyance amount (Wx) changes according to replenishment of replenishment toner, and in a comparison example in which the web conveyance amount does not change (here, 0.08 mm/sheet). The numerals 1 to 9 within parentheses in FIG. 10 indicate the number of times of replacement of the toner bottle 7d, and the arrows in FIG. 10 each indicate the direction of change in the web conveyance amount. Here, the toner bottle 7d is replaced with a new toner bottle 7d when the number of times of replenishment from the toner bottle 7d reaches 5000 times.

When the arrows illustrated in FIG. 10 point upward, the melting characteristics of the replenishment toner contained in the toner bottle 7d are higher than the melting characteristics of the toner contained in the development device 1d. Since the melting characteristics of the replenishment toner contained in the toner bottle 7d are higher, the web conveyance amount (Wx) increases according to the replenishment of the replenishment toner. On the other hand, when the arrows illustrated in FIG. 10 point downward, the melting characteristics of the replenishment toner contained in the toner bottle 7d are lower than the melting characteristics of the toner contained in the development device 1d. Since the melting characteristics of the replenishment toner contained in the toner bottle 7d are lower, the web conveyance amount (Wx) decreases according to the replenishment of the replenishment toner. As described above, in the present embodiment, the web conveyance amount (Wx) is corrected each time according to the number of times of replenishment, based on the melting characteristics of the replenishment toner contained in the toner bottle 7d. Therefore, in comparison to the comparison example, the web 61 can be prevented from being wasted. In the comparison example, the lifetime of the web 61 was 500K sheets, whereas in the present embodiment, it was confirmed that the lifetime of the web 61 can be extended to 530K sheets.

As described above, in the present embodiment, the web conveyance amount (Wx), which is to be used when the winding operation of the web 61 is executed by driving the web winding motor 210, is changed depending on the melting characteristics of the toner contained in the development device 1d. The melting characteristics of the toner contained in the development device 1d may change when the development device 1d is replaced. In addition, the melting characteristics of the toner contained in the development device 1d may change according to the replenishment of the replenishment toner to the development device 1d from the toner bottle 7d. The amount of offset toner adhering to the fixing belt 42 varies depending on the melting characteristics of the toner contained in the development device 1d. Therefore, as described in the present embodiment, by changing the web conveyance amount (Wx) per operation of the web 61 for removing offset toner adhering to the fixing belt 42 according to the melting characteristics of the toner contained in the development device 1d, the web 61 can be prevented from being wasted, and the lifetime of the web 61 can be improved.

### Other Embodiment

In the above-described embodiment, for the sake of easy understanding, the web conveyance amount (Wx) has been described by taking, as an example, a monochrome mode in which a black toner image is formed by using only the black image forming unit Pd. However, in a case where a full-color toner image is formed in a color mode by using the image forming units Pa to Pd for the respective colors, four development devices 1a to 1d and four toner bottles 7a to 7d are present, and the melting characteristics of the toner contained in the four development devices 1a to 1d may be different from each other. Therefore, a method for setting the web conveyance amount (Wx) in the color mode in which the four development devices 1a to 1d and the four toner bottles 7a and 7d are present will be described. In this case, the control unit 150 executes the above-described processing illustrated in FIGS. 6 to 8 for each of the four development devices 1a to 1d.

Here, the web conveyance correction amount 1 stored in each of the development storage units 116 included in the development devices 1a to 1d is denoted as follows for each of the colors Y, M, C, and K.
Y: Web Conveyance Correction Amount 1 (Qxy)
M: Web Conveyance Correction Amount 1 (Qxm)
C: Web Conveyance Correction Amount 1 (Qxc)
K: Web Conveyance Correction Amount 1 (Qxk)

Further, the web conveyance correction amount 2 stored in each of the bottle storage units 115 included in the toner bottles 7a to 7d is denoted as follows for each of the colors Y, M, C, and K.
Y: Web Conveyance Correction Amount 2 (Pxy)
M: Web Conveyance Correction Amount 2 (Pxm)
C: Web Conveyance Correction Amount 2 (Pxc)
K: Web Conveyance Correction Amount 2 (Pxk)

The web conveyance amounts (the first web conveyance amount and the second web conveyance amount) for the colors Y, M, C, and K, which are determined according to “Wx=W0+Qx” (Equation 1) described above and stored in the non-volatile memory 154, are denoted as follows.
Y: Web Conveyance Amount (Wxy)
M: Web Conveyance Amount (Wxm)
C: Web Conveyance Amount (Wxc)
K: Web Conveyance Amount (Wxk)

In the color mode, since the ratio of toner coverage for each of the YMCK colors varies depending on the image pattern, it is necessary to set a web conveyance amount that can remove offset toner in various image patterns. In the present embodiment, one of the web conveyance amounts (Wxy to Wxk) for the colors Y, M, C, and K that tends to have a relatively large amount of offset toner is set as the web conveyance amounts (Wx) in the color mode according to the following equation 4. In other words, the web conveyance amounts (Wxy to Wxk) are compared to each other, and the web conveyance amount (Wx) is changed based on the web conveyance amount having the greatest value.

$$Web Conveyance Amount ( Wx ) = MAX ( [ Wxy ] , [ Wxm ] , [ Wxc ] , [ Wxk ] ) \qquad Equation 4$$

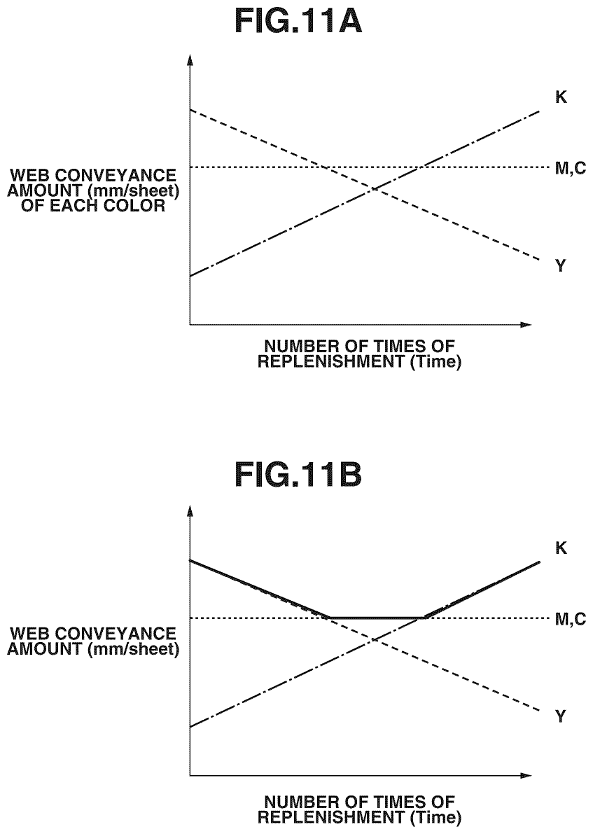

A specific description will be given with reference to Table 5 and FIGS. 11A and 11B.

TABLE 5

| | | | | | Web Conveyance | |
|---|---|---|---|---|---|---|
| | Web Conveyance Amount | | | | Amount (Wx) | |
| | for Each Color | | | | Color | Monochrome |
| | Y | M | C | K | Mode | Mode |
| Specific | 0.072 | 0.078 | 0.074 | 0.072 | 0.078 | 0.072 |
| Example 1 | | | | | | |
| Specific | 0.070 | 0.072 | 0.077 | 0.073 | 0.077 | 0.073 |
| Example 2 | | | | | | |
| Specific | 0.078 | 0.076 | 0.075 | 0.075 | 0.078 | 0.075 |
| Example 3 | | | | | | |
| Specific | 0.075 | 0.077 | 0.073 | 0.079 | 0.079 | 0.079 |
| Example 4 | | | | | | |

As illustrated in “Specific Example 1” of Table 5, it is assumed that the web conveyance amount (Wxy) is “0.072 mm/sheet,” the web conveyance amount (Wxm) is “0.078 mm/sheet,” the web conveyance amount (Wxc) is “0.074 mm/sheet,” and the web conveyance amount (Wxk) is “0.072 mm/sheet.” In this case, the maximum value, i.e., “0.078 mm/sheet,” is set as the web conveyance amount (Wx) in the color mode. On the other hand, the web conveyance amount (Wxk), i.e., “0.072 mm/sheet,” is set as the web conveyance amount (Wx) in the monochrome mode as described above. Similarly, in the case of “Specific Example 2”, the maximum value, i.e., “0.077 mm/sheet,” is set as the web conveyance amount (Wx) in the color mode, and the web conveyance amount (Wxk), i.e., “0.073 mm/sheet,” is set as the web conveyance amount (Wx) in the monochrome mode. In the case of “Specific Example 3”, the maximum value, i.e., “0.078 mm/sheet,” is set as the web conveyance amount (Wx) in the color mode, and the web conveyance amount (Wxk), i.e., “0.075 mm/sheet,” is set as the web conveyance amount (Wx) in the monochrome mode. In the case of “Specific Example 4”, the maximum value, i.e., “0.079 mm/sheet,” is set as the web conveyance amount (Wx) in the color mode, and the web conveyance amount (Wxk), i.e., “0.079 mm/sheet,” is set as the web conveyance amount (Wx) in the monochrome mode.

In the above description, when the replenishment toner contained in the toner bottles 7a to 7d is supplied to the development devices 1a to 1d of corresponding colors, the melting characteristics of the toner within the development devices 1a to 1d change according to the melting characteristics of the replenishment toner contained in the toner bottles 7a to 7d. As illustrated in FIG. 11A, each time the replenishment toner contained in the toner bottles 7a to 7d is supplied to the development devices 1a to 1d, the web conveyance amounts (Wxy to Wxk) for the respective colors are updated. Then, as indicated with a bold line in FIG. 11B, from among the web conveyance amounts (Wxy to Wxk), the web conveyance amount having the maximum value is set as the web conveyance amount (Wx) in the color mode, so that the cleaning unit 60 is driven in accordance with the maximum web conveyance amount.

In addition, the web conveyance amount (Wx) in the color mode is not limited to being set to the maximum value among the above-described web conveyance amounts (Wxy to Wxk). For example, the web conveyance amount (Wx) may be set to the average value of the web conveyance amounts (Wxy to Wxk) for the colors Y, M, C, and K, in accordance with the following equation 5.

$$Web Conveyance Amount ( Wx ) = Ave ( [ Wxy ] , [ Wxm ] , [ Wxc ] , [ Wxk ] ) \qquad Equation 5$$

A specific description will be given with reference to Table 6.

TABLE 6

| | | | | | Web Conveyance | |
|---|---|---|---|---|---|---|
| | Web Conveyance Amount | | | | Amount (Wx) | |
| | for Each Color | | | | Color | Monochrome |
| | Y | M | C | K | Mode | Mode |
| Specific | 0.072 | 0.078 | 0.074 | 0.072 | 0.074 | 0.072 |
| Example 1 | | | | | | |
| Specific | 0.070 | 0.072 | 0.077 | 0.073 | 0.073 | 0.073 |
| Example 2 | | | | | | |
| Specific | 0.078 | 0.076 | 0.075 | 0.075 | 0.076 | 0.075 |
| Example 3 | | | | | | |
| Specific | 0.075 | 0.077 | 0.073 | 0.079 | 0.076 | 0.079 |
| Example 4 | | | | | | |

As illustrated in “Specific Example 1” of Table 6, it is assumed that the web conveyance amount (Wxy) is “0.072 mm/sheet,” the web conveyance amount (Wxm) is “0.078 mm/sheet,” the web conveyance amount (Wxc) is “0.074 mm/sheet,” and the web conveyance amount (Wxk) is “0.072 mm/sheet.” In this case, the average value of these web conveyance amounts, i.e., “0.074 mm/sheet,” is set as the web conveyance amount (Wx) in the color mode. On the other hand, the web conveyance amount (Wxk), i.e., “0.072 mm/sheet,” is set as the web conveyance amount (Wx) in the monochrome mode as described above. Similarly, in the case of “Specific Example 2”, the average value, i.e., “0.073 mm/sheet,” is set as the web conveyance amount (Wx) in the color mode, and the web conveyance amount (Wxk), i.e., “0.073 mm/sheet,” is set as the web conveyance amount (Wx) in the monochrome mode. In the case of “Specific Example 3”, the average value, i.e., “0.076 mm/sheet,” is set as the web conveyance amount (Wx) in the color mode, and the web conveyance amount (Wxk), i.e., “0.075 mm/sheet,” is set as the web conveyance amount (Wx) in the monochrome mode. In case of “Specific Example 4”, the average value, i.e., “0.076 mm/sheet,” is set as the web conveyance amount (Wx) in the color mode, and the web conveyance amount (Wxk), i.e., “0.079 mm/sheet,” is set as the web conveyance amount (Wx) in the monochrome mode.

As described above, in the color mode, the maximum value among the web conveyance amounts (Wxy to Wxk) for the colors Y, M, C, and K, or the average value of the web conveyance amounts (Wxy to Wxk) for the colors Y, M, C, and K, is set as the web conveyance amount (Wx) used when executing the winding operation of the web 61 by driving the web winding motor 210. In this manner, it is possible to set an optimal web conveyance amount (Wx) based on the web conveyance amounts (Wxy to Wxk) updated for the respective colors. As a result, even if offset toner in amount different among the different colors adheres to the fixing belt 42 depending on the melting characteristics of toner contained in the development devices 1a to 1d, the offset toner can be removed from the fixing belt 42 without wasting the web 61. Therefore, it is possible to improve the lifetime of the web 61.

In addition, the web conveyance amount in the color mode may be changed according to the toner usage ratio for each color (color ratio information) in the image.

Although the web conveyance amount based on the toner melting characteristics related to hot offset has been described in the above-described embodiment, it is apparent that similar effects can be obtained by setting the web conveyance amount based on the toner melting characteristic value related to electrostatic offset in a case where the web conveyance amount is calculated from a plurality of toner melting characteristic values. Further, although the target web conveyance amount (W0) has been described as a fixed value, i.e., 0.08 mm/sheet, the target web conveyance amount (W0) is not limited to the fixed value, and may be variable as appropriate depending on the installation environment, the amount of toner deposition, the target temperature, and the basis weight of the recording material S.

In addition, the cleaning unit 60 is not limited to a cleaning mechanism for removing offset toner adhering to the fixing belt 42, and may also be a cleaning mechanism for removing offset toner adhering to the surface of the pressure roller 41. Further, the fixing device 9 may have a roller-shape fixing roller instead of the fixing belt 42, and the cleaning unit 60 may be a cleaning mechanism which removes offset toner adhering to the fixing roller.

According to the present disclosure, it is possible to improve the lifetime of the web without wasting the web since the web is wound by changing the web conveyance amount per operation according to the melting characteristics of toner contained in the development unit.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-200635, filed Nov. 18, 2024, which is hereby incorporated by reference herein in its entirety.

What is claimed is:

1. An image forming apparatus comprising:
a photosensitive member on which an electrostatic latent image is formed;
a development unit configured to develop the electrostatic latent image formed on the photosensitive member into a toner image with toner;
a transfer unit configured to transfer the toner image on the photosensitive member onto a recording material;
a fixing unit including a first rotating member and a second rotating member, the second rotating member being in contact with the first rotating member to form a fixing nip portion in which the toner image is fixed to the recording material by applying heat and pressure while holding and conveying the recording material;
a cleaning unit including a web for removing toner and a winding unit configured to wind the web, and configured to clean the first rotating member by removing toner adhering to a surface of the first rotating member;
a driving unit configured to drive the winding unit;
a storage unit configured to store information related to melting characteristics of toner contained in a toner bottle; and
a control unit configured to control the driving unit based on the information stored in the storage unit.

2. The image forming apparatus according to claim 1, wherein the control unit controls winding of the web executed by the driving unit by changing a web conveyance amount per sheet based on the information stored in the storage unit.

3. The image forming apparatus according to claim 2, wherein the control unit determines the web conveyance amount per sheet by correcting a predetermined conveyance amount based on the information stored in the storage unit.

4. The image forming apparatus according to claim 1,
wherein the photosensitive member is a first photosensitive member,
wherein the development unit is a first development unit configured to develop an electrostatic latent image formed on the first photosensitive member into a toner image using a first toner contained in a first toner bottle,
wherein the image forming apparatus further comprises:
a second photosensitive member on which an electrostatic latent image is formed; and
a second development unit configured to develop the electrostatic latent image formed on the second photosensitive member into a toner image using a second toner contained in a second toner bottle, the second toner having melting characteristics different from the melting characteristics of the first toner,
wherein the transfer unit transfers the toner images on the first photosensitive member and the second photosensitive member onto a recording material, and
wherein the control unit controls the driving unit based on information related to melting characteristics of the first toner contained in the first toner bottle and information related to melting characteristics of the second toner contained in the second toner bottle.

5. The image forming apparatus according to claim 4, wherein the control unit controls the driving unit based on a web conveyance amount having a greater value between a first web conveyance amount based on the information related to the melting characteristics of the first toner contained in the first toner bottle and a second web conveyance amount based on the information related to the melting characteristics of the second toner contained in the second toner bottle.

6. The image forming apparatus according to claim 4, wherein the control unit controls the driving unit based on an average value of a first web conveyance amount based on the information related to the melting characteristics of the first toner contained in the first toner bottle and a second web conveyance amount based on the information related to the melting characteristics of the second toner contained in the second toner bottle.

7. The image forming apparatus according to claim 1,
wherein the cleaning unit further includes an intermediate rotating member disposed between the web and the first rotating member and configured to clean a surface of the first rotating member while being in contact with the first rotating member, and
wherein the web rubs against the intermediate rotating member to remove toner transferred from the first rotating member to the intermediate rotating member.

8. The image forming apparatus according to claim 7, wherein the cleaning unit further includes a pressing rotating member configured to press the web toward the intermediate rotating member.

9. An image forming apparatus comprising:
a photosensitive member on which an electrostatic latent image is formed;
a development unit configured to develop the electrostatic latent image formed on the photosensitive member into a toner image with toner;
a transfer unit configured to transfer the toner image on the photosensitive member to a recording material;
a fixing unit including a first rotating member and a second rotating member, the second rotating member being in contact with the first rotating member to form a fixing nip portion in which the toner image is fixed to the recording material by applying heat and pressure while holding and conveying the recording material;
a cleaning unit including a web for removing toner and a winding unit configured to wind the web, and configured to clean the first rotating member by removing toner adhering to a surface of the first rotating member;
a driving unit configured to drive the winding unit;
a first storage unit included in the development unit that is detachably mountable to the photosensitive member, and configured to store information related to melting characteristics of toner contained in the development unit; and
a control unit configured to control the driving unit based on the information stored in the first storage unit.

10. The image forming apparatus according to claim 9, wherein, in a case where the development unit is replaced, the control unit controls the driving unit based on information acquired by an acquisition unit from the first storage unit of the development unit after replacement.

11. The image forming apparatus according to claim 9, wherein the information is a first conveyance correction amount which the control unit uses in order to change the web conveyance amount by correcting a predetermined conveyance amount determined set in advance.

12. The image forming apparatus according to claim 11, further comprising a replenishment container detachably mounted to the developing unit and configured to contain replenishment toner to be supplied to the development unit,
wherein, in a case where replenishment toner having melting characteristics different from the melting characteristics of the toner contained in the development unit is supplied from the replenishment container to the development unit, the control unit updates the first conveyance correction amount according to a ratio of the toner having different melting characteristics contained in the development unit after replenishment, and changes the web conveyance amount by correcting the predetermined conveyance amount using the updated first conveyance correction amount.

13. The image forming apparatus according to claim 12,
wherein the replenishment container includes a second storage unit configured to store a second conveyance correction amount corresponding to melting characteristics of the replenishment toner contained therein, and
wherein, when the first conveyance correction amount after updating is denoted by Qx+1 (mm/sheet), the first conveyance correction amount before updating is denoted by Qx (mm/sheet), the second conveyance correction amount is denoted by Px (mm/sheet), a cumulative toner consumption amount used for development is denoted by ΣCx (g), and an amount of toner in the development unit before replenishment is Fx (g), the control unit calculates the first conveyance correction amount Qx+1 according to the following equation:
Qx+1=(Fx×Qx+ΣCx×Px)/(Fx+ECx).
